(19) United States
(12) Patent Application Publication
(10) Pub. No.: US 2017/0103154 A1
(43) Pub. Date: Apr. 13, 2017

(54) CIRCUIT DESIGN METHOD AND SIMULATION METHOD BASED ON PROCESS VARIATION CAUSED BY AGING

(71) Applicant: SAMSUNG ELECTRONICS CO., LTD., Suwon-Si (KR)

(72) Inventors: JONG-WOOK JEON, SUWON-SI (KR); JAE-HEE CHOI, SEOUL (KR); YOO-HWAN KIM, SUWON-SI (KR); KEUN-HO LEE, SEONGNAM-SI (KR); UI-HUI KWON, HWASEONG-SI (KR); JONG-CHOL KIM, SEOUL (KR)

(21) Appl. No.: 15/251,411

(22) Filed: Aug. 30, 2016

(30) Foreign Application Priority Data
Oct. 13, 2015 (KR) 10-2015-0143048

(51) Int. Cl. G06F 17/50

(52) U.S. Cl. CPC G06F 17/5036; G06F 17/505

(57) ABSTRACT

A circuit design method includes extracting aging information of each of multiple devices from a netlist including one or more devices and a model library including information associated with a process variation. An arithmetic operation is performed using the information associated with the process variation and the aging information to calculate a deviation of the process variation of each device caused by aging. A netlist and/or a model library is extracted in which the calculated deviation is reflected.

### CROSS-REFERENCE TO RELATED APPLICATION

This application claims the benefit of Korean Patent Application No. 10-2015-0143048, filed on Oct. 13, 2015, in the Korean Intellectual Property Office, the disclosure of which is incorporated herein in its entirety by reference.

### BACKGROUND

The disclosure relates to a circuit design method and a simulation method, and more particularly, to a circuit design method and a simulation method, which accurately reflect the actual characteristic of a circuit.

A tool for designing and simulating an integrated circuit (IC) is generally used. Generally, an integrated circuit (IC) is implemented by arranging a plurality of circuits with a circuit schematic tool (hereinafter referred to as a schematic tool), and an operation of an IC implemented with a schematic tool may be verified by using a simulation tool. An example of the simulation tool includes a program referred to as simulation program with integrated circuit emphasis (SPICE).

The schematic tool provides a netlist corresponding to a designed IC. A connection relationship of circuit elements connected to each other in the IC may be explained by using the netlist. Also, the schematic tool may provide, as a simulation tool, a model library including various device models having the characteristic of a circuit element (for example, a device) included in the designed IC.

Due to the progress of aging, devices included in an IC are degraded in characteristic. Also, the degrees of characteristic degradation of devices differ. In addition, a designed IC may be manufactured through a certain process, and devices included in the IC may have various process deviations. However, the characteristics of the devices included in the IC are changed by various factors, and for this reason, it is difficult to obtain a result, in which actual circuit characteristic is accurately reflected, in a simulation process.

### SUMMARY

The disclosure provides a circuit design method and a simulation method, which more accurately reflect the actual characteristic of a circuit.

According to an aspect of the disclosure, there is provided a circuit design method that includes extracting aging information of one or more devices included in a netlist and extracting a model library including information associated with a process variation. An arithmetic operation is performed using the information associated with the process variation and the aging information to calculate a deviation of the process variation caused by aging, for each of the one or more devices. At least one of a netlist and a model library are extracted, and the calculated deviation is reflected in the extracted netlist or the extracted model library.

According to another aspect of the disclosure, there is provided a circuit design method that includes receiving a netlist, performing an arithmetic operation by using information associated with process variations of a plurality of devices included in the netlist and aging information indicating a degree of characteristic degradation caused by aging for each of the one or more devices, calculating a deviation of at least one characteristic of each of the plurality of devices in which the aging information is reflected, based on a result of the arithmetic operation, and outputting a modified netlist according to the calculated deviation.

According to an aspect of the disclosure, there is provided a circuit simulation method that includes receiving a netlist and a model library, the model library including information associated with a process variation each of a plurality of devices included in the model library. A deviation of at least one characteristic of each of the plurality of devices caused by aging is calculated based on the information included in the model library and aging information of each of the plurality of devices, the aging information indicating a degree of characteristic degradation caused by aging. A simulation is performed using a modified netlist generated based on the calculated deviation.

According to another aspect of the disclosure, there is provided a computer-based simulation system that includes an input unit configured to receive information associated with simulation processing. A memory is configured to store information associated with a process variation of each of a plurality of devices included in a netlist and information associated with aging of each of the plurality of devices. A controller is configured to perform an arithmetic operation using the information associated with the process variation and the information associated with aging of each of the plurality of devices, calculate a deviation of the process variation of each of the plurality of devices caused by aging, and generate a modified netlist reflecting the calculated deviation. An output unit is configured to output simulation results generated by a simulation which is performed using the modified netlist.

According to another aspect of the disclosure, there is provided a computer system having a central processing unit (CPU) and a working memory. The working memory includes an operational module that when executed by the CPU: (1) extracts aging information of each of one or more devices using a netlist including the one or more devices and a model library including information associated with a process variation, (2) calculates a deviation of the process variation due to aging by performing an arithmetic operation using the information associated with the process variation and the aging information, for each of the one or more devices, and (3) extracts a revised netlist or a revised model library. The calculated deviation is reflected in the revised netlist or revised model library.

### BRIEF DESCRIPTION OF THE DRAWINGS

Embodiments of the disclosure will be more clearly understood from the following detailed description taken in conjunction with the accompanying drawings in which:

FIG. 1 is a block diagram illustrating an implementation example of a simulation device according to embodiments;

FIGS. 2A, 2B, 3 and 4 are block diagrams illustrating an example where a process variation caused by aging is applied to, through various methods, a circuit schematic tool or a simulation tool according to embodiments;

FIGS. 5 and 6 are graphs showing an example where devices have different process variations due to the progress of aging;

FIG. 7 is a flowchart illustrating a simulation method according to embodiments;

FIG. 8 is a diagram illustrating an example of generating a model library in which a process variation caused by aging is reflected, according to embodiments;

FIG. 9 is a circuit diagram illustrating an example where different deviations are applied to devices, according to embodiments;

FIG. 10 is a graph showing an example of a process variation of a simulated device;

FIG. 11 is a table showing an example of a simulation result based on a process variation of a threshold voltage of a transistor;

FIG. 12 is a flowchart illustrating a simulation method according to an embodiment;

FIG. 13 is a diagram illustrating an example of a netlist associated with an operation according to the embodiment of FIG. 12;

FIG. 14 is a flowchart illustrating a simulation method according to another embodiment;

FIG. 15 is a diagram illustrating an example of a model library associated with an operation according to the embodiment of FIG. 14;

FIG. 16 is a flowchart illustrating a simulation method according to another embodiment;

FIG. 17 is a block diagram illustrating a computing system for performing a simulation method, according to an embodiment; and

FIG. 18 is a block diagram illustrating an example where a function according to embodiments is implemented in software.

### DETAILED DESCRIPTION OF THE EMBODIMENTS

Hereinafter, example embodiments of the disclosure will be described in detail with reference to the accompanying drawings. Embodiments of the disclosure are provided so that this disclosure will be thorough and complete and will fully convey the concept of the disclosure to one of ordinary skill in the art. Since the disclosure may have diverse modified embodiments, preferred embodiments are illustrated in the drawings and are described in the detailed description of the disclosure. However, this does not limit the disclosure within specific embodiments and it should be understood that the disclosure covers all the modifications, equivalents, and replacements within the idea and technical scope of the disclosure. Like reference numerals refer to like elements throughout. In the drawings, the dimensions and size of each structure are exaggerated, reduced, or schematically illustrated for convenience in description and clarity.

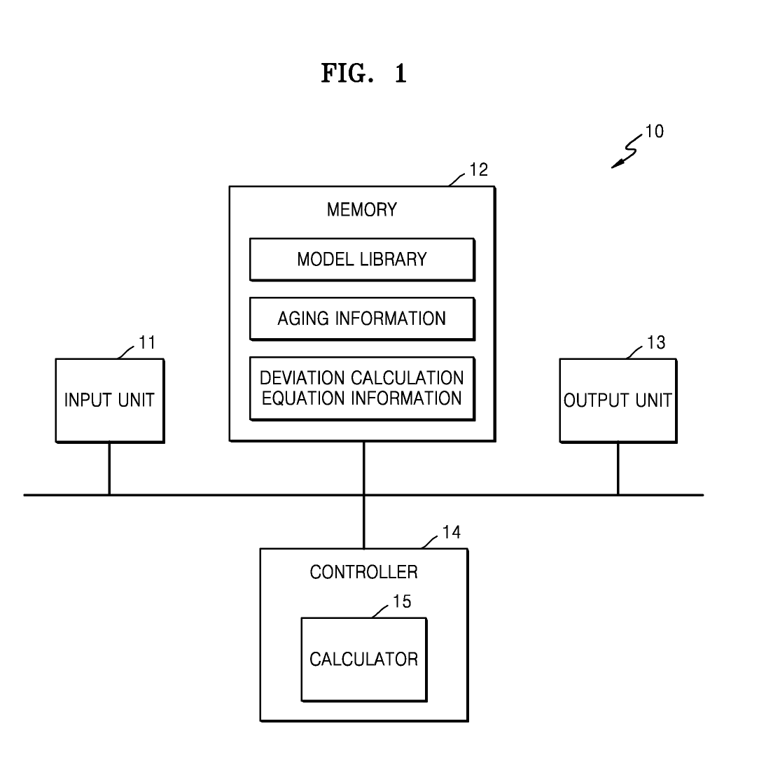

FIG. 1 is a block diagram illustrating an implementation example of a simulation device 10 according to embodiments. According to an embodiment, the simulation device 10 of FIG. 1 may be defined as a system for performing various functions. For example, the simulation device 10 may be a computer-based simulation system and may be a system that receives various pieces of information associated with simulation processing and outputs a simulation result.

For example, the simulation device 10 may be a system that arranges and connects a plurality of circuit elements by using a model library including a plurality of device models and provides and a netlist corresponding to the arrangement and connection. Alternatively, the simulation device 10 may be a system that generates a netlist corresponding to the arrangement and connection of circuit elements and simulates a circuit by using the generated netlist and a model library. In addition, the simulation device 10 may be defined as a system that simulates a circuit by using a model library and a netlist generated according to embodiments.

The netlist may indicate a connection relationship between circuit elements included in a designed circuit, a connection relationship between function blocks configured with circuit elements, and node information based on a connection of circuit elements. A structure of a circuit may be obtained through the netlist. Hereinafter, in describing embodiments, a circuit (or a designed circuit) may denote an IC, and a device included in a circuit may be defined as a circuit element included in an IC.

The simulation device 10 may include an input unit 11, a memory 12, an output unit 13, and a controller 14. Also, the controller 14 may include a calculator 15. The input unit 11, the memory 12, the output unit 13, and the controller 14 may be connected to each other through a bus. The controller 14 may control the input unit 11, the memory 12, and the output unit 13.

The input unit 11 may be configured with, for example, a keyboard, a manipulation panel, or various data read devices. The memory 12 may be configured with various semiconductor memories, a hard disk, and/or the like. The output unit 13 may be configured with a monitor, a printer, a recording device, and/or the like. The controller 14 may perform various processing operations associated with a simulation, and for example, the controller 14 may generate a model library and a netlist in which a process variation caused by aging is reflected, or may control performing of a simulation in which a process variation caused by aging is reflected.

For example, according to an embodiment, the controller 14 may receive a netlist in which an aging effect is not reflected, calculate characteristic degradation information (for example, aging information) caused by aging of devices included in the netlist, and perform an arithmetic operation on information (for example, a process deviation) associated with a process variation and the calculated aging information to generate a modified netlist. The modified netlist may be a netlist in which a process variation caused by aging is reflected. The calculator 15 may perform various arithmetic operations in association with the above-described operation.

A plurality of circuits manufactured through the same process may have different deviations in characteristic of a certain device. That is, a process variation may be defined based on a mean and a deviation of characteristics of devices, and information associated with the process variation may include a mean and deviation information which correspond to process variations of devices.

The controller 14 may generate a new model library having different process deviations of devices caused by aging, based on a result of the arithmetic operation. Also, the controller 14 may perform a simulation by using the modified netlist and the new model library generated according to an embodiment.

The memory 12 may store various pieces of information used for the arithmetic operation according to an embodiment and may also store various arithmetic operation results. Also, a result of the simulation which has been performed by using the modified netlist and the new model library generated according to an embodiment may be stored in the memory 12. In addition, the memory 12 may store a control program which is used to calculate aging information about each device, calculate a deviation of a process variation caused by aging of each device, or generate a netlist and/or a model library in which the calculated deviation is reflected. The controller 14 may execute the stored control program to perform various operations according to embodiments.

As aging of devices included in a circuit progresses, the characteristics of the devices may be degraded, and the degrees of characteristic degradation of the devices may differ depending on various operating environments (for example, a bias condition and/or the like). For example, in a transistor implemented with a field effect transistor (FET) as an example of a device, as aging of the transistor progresses due to bias temperature instability (BTI) or hit carrier injection (HCI), a threshold voltage may be shifted, causing problems due to performance degradation and voltage sensitivity.

Referring to the threshold characteristic of a transistor, in a case where a plurality of circuits is manufactured, the threshold voltage characteristics of certain transistors of the circuits may have a certain mean. As aging progresses, the threshold voltage characteristics (for example, a mean) of the transistors may be changed, and threshold voltages of the transistors may be differently changed. Information associated with a change in characteristic caused by aging may be stored as aging information in the memory 12.

Moreover, in a case where a plurality of circuits is manufactured through a certain manufacturing process, devices may have a variation characteristic caused by the manufacturing process. To describe the threshold voltage characteristic of a transistor as an example, the devices may have a certain threshold voltage mean and a process deviation (for example, sigma “σ”). Information about the threshold voltage mean and the process deviation may be supplied by a manufacturer for a particular process and may be reflected in a model library. For example, a model library including deviation information in which aging of devices is not reflected may be stored in the memory 12.

In an IC, as aging of devices progresses, means of characteristics (for example, threshold voltage levels) of the devices may be differently changed, and deviations of the devices may be differently changed. That is, as aging progresses, a process variation of each of some devices (for example, devices having bad aging characteristic) may be widely distributed, and a process variation of each of the other devices (for example, devices having good aging characteristic) may be narrowly distributed.

According to an embodiment, in simulating a designed circuit, a characteristic change of each device caused by aging may be accurately reflected, thereby enhancing a simulation result. For example, an arithmetic operation may be performed for process deviation information and aging information, and deviations of devices having different values may be calculated as a result of the arithmetic operation. For example, it is assumed that as first and second transistors included in the same semiconductor chip operate under different bias conditions, a degree of characteristic degradation of the first transistor caused by aging is higher than that of characteristic degradation of the second transistor caused by aging. In this case, as aging progresses, a variation of a threshold voltage of the first transistor may become higher than that of the second transistor, and thus, a deviation calculated for the first transistor may have a value larger than the second transistor.

According to an embodiment, a characteristic change and a process deviation caused by aging may be applied to each of multiple devices. For example, a characteristic change of each device caused by aging may be determined based on the aging information stored in the memory 12. Also, in order to determine a process variation of each device caused by aging, an arithmetic operation may be performed for a process deviation of each device in which aging is not reflected and characteristic change information in which aging is reflected, and thus, deviations having different values may be respectively applied to the devices. As described above, deviation calculation equation information for calculating a process deviation of each device may be stored in the memory 12. For example, a characteristic change (for example, a mean in which aging is reflected) of each device caused by aging may be reflected in a netlist, and a process variation (for example, a process deviation in which aging is reflected) of each device caused by aging may be reflected in the netlist or a model library.

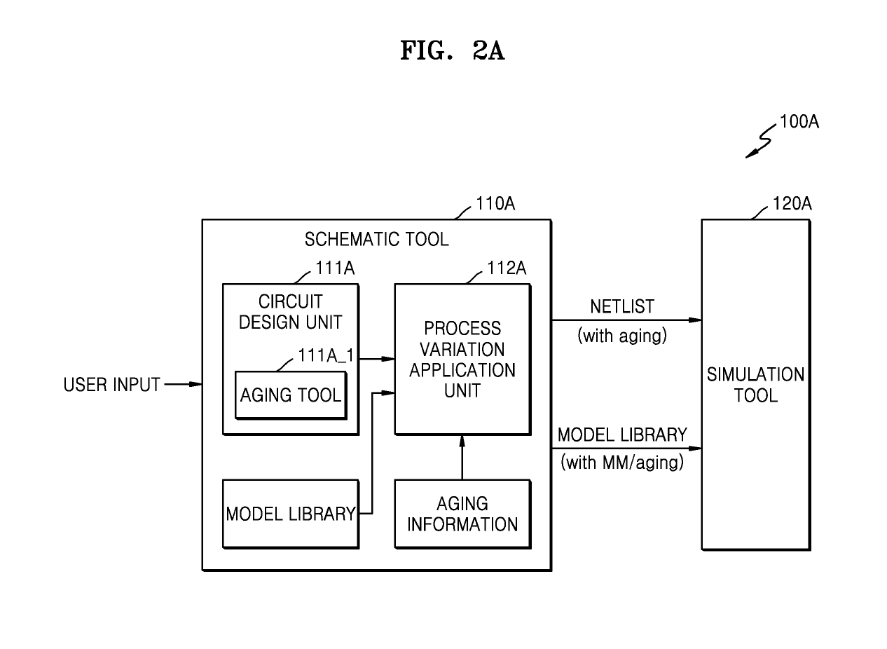

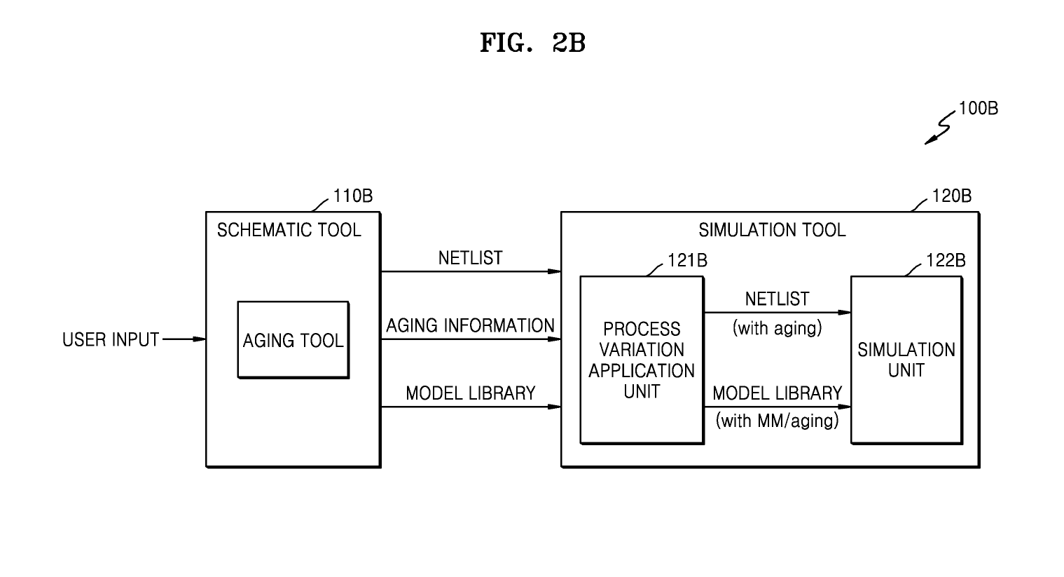

A detailed operation of the simulation device 10 according to embodiments illustrated in FIG. 1 will be described with reference to FIGS. 2A, 2B, 3 and 4. FIGS. 2A, 2B, 3 and 4 are block diagrams illustrating an example where a process variation caused by aging is applied to, through various methods, a circuit schematic tool or a simulation tool according to embodiments.

Referring to FIG. 2A, a simulation system 100A may include a schematic tool 110A and a simulation tool 120A according to embodiments. The schematic tool 110A and the simulation tool 120A may each be implemented with a program executable by a computer. The schematic tool 110A may design a circuit according to a user input and may supply, to the simulation tool 120A, a netlist and a model library based on a result of the circuit design.

The netlist and the model library supplied to the simulation tool 120A may respectively be a netlist and a model library in which a process deviation of each device caused by aging is reflected according to embodiments. For example, the netlist supplied to the simulation tool 120A may be a netlist (a netlist with aging) in which an aging effect is reflected for each device, and the model library supplied to the simulation tool 120A may be a model library (a model library with MM/aging) having different process deviations of the devices caused by aging. Furthermore, according to embodiments, information about the different process deviations of the devices caused by aging may be reflected in the netlist and the model library in various forms, and thus, embodiments may be variously modified. A process deviation applied to each device may show a deviation of a characteristic variation of each device in a plurality of circuits manufactured through the same process. In the following description, for convenience of description, the process deviation may be referred to as a deviation. Also, the simulation tool 120A may simulate a circuit by using the netlist and the model library.

The schematic tool 110A may include a circuit design unit 111A and a process variation application unit 112A. A model library including device models in which parameters corresponding to a plurality of devices are defined may be added into the schematic tool 110A as various pieces of information associated with circuit design. The circuit design unit 111A may generate a netlist indicating circuit design (for example, arrangement of devices and a connection state between the devices) based on a user input and may supply the netlist to the process variation application unit 112A. The user input may include information about a selection and connection of devices. The netlist from the circuit design unit 111A may be a netlist to which aging of devices is not applied.

The circuit design unit 111A may include an aging tool 111A_1 that generates aging information indicating a characteristic change of each device of a designed circuit caused by aging. The aging tool 111A_1 may calculate a degree of characteristic change caused by aging for each device included in the designed circuit with reference to the netlist to which aging is not applied. For example, the aging tool 111A_1 may generate different pieces of aging information of the devices depending on an operating environment of each device included in the netlist. The generated aging information may be stored in the schematic tool 110A.

As an example of an operation, the aging tool 111A_1 may supply a netlist, in which aging is not reflected, to the simulation tool 120A to allow a simulation to be performed, and the aging tool 111A_1 may receive a result of the simulation and may generate aging information, based on the received simulation result.

In FIG. 2A, the aging tool 111A_1 is illustrated as being included in the circuit design unit 111A. However, in other embodiments, the aging tool 111A_1 may be implemented as a tool independent from the circuit design unit 111A and the process variation application unit 112A.

The process variation application unit 112A may check devices and a connection state thereof which are included in the netlist from the circuit design unit 111A. According to an embodiment, the process variation application unit 112A may calculate a process variation caused by aging for each of various devices included in a circuit and may apply the calculated process variation. For example, the process variation application unit 112A may perform an arithmetic operation on each device included in the netlist from the circuit design unit 111A by using various parameters included in a model library and aging information (or aging information supplied from the circuit design unit 111A) which are stored in the schematic tool 110A. Deviations caused by aging for each of the same devices included in the circuit may be calculated as having different values, based on a result of the arithmetic operation.

To describe first and second transistors as an example of devices to which a process variation caused by aging is applied, a deviation and a mean of a threshold voltage of each of the first and second transistors may be checked based on a netlist including the first and second transistors and a device model corresponding to the netlist. For example, the device model may include deviation information which is applied to the first and second transistors in common As aging progresses, the characteristics of the first and second transistors may be differently degraded depending on operating environments of the first and second transistors. For example, a change amount of a mean of a threshold voltage of each device may be checked based on aging information. According to an embodiment, a change amount (for example, a deviation) of a process variation of each device caused by aging may be calculated by performing an arithmetic operation on the aging information and deviation information included in a pre-stored model library.

The schematic tool 110A may supply a model library and a netlist, in which a process deviation caused by aging is reflected, to the simulation tool 120A. For example, the netlist from the schematic tool 110A may define various devices, and a netlist into which instance parameters having different deviations of devices are added may be supplied to the simulation tool 120A. For example, a deviation and a change amount of a threshold voltage caused by aging for each device may be reflected in the netlist.

Moreover, in association with a model library, a first device model corresponding to the first transistor and a second device model corresponding to the second transistor may be separately generated by using a device model which indicates the characteristics of the first and second transistors in common As described above, the model library including the separately generated device models may be supplied to the simulation model 120A. Although not shown in FIG. 2A, the generated model library may be additionally stored in the schematic tool 110A. For example, a change amount of a threshold voltage caused by aging for each device may be reflected in the netlist, and a deviation calculated for each device may be reflected in a new model library.

Moreover, when a model library including a plurality of device models is newly generated through the above-described method, a state of a netlist having a before-change hierarchical structure may be changed to a flatten state. For example, a plurality of devices may share a device model according to a hierarchical structure, and thus, a before-change netlist may have characteristic where deviation information is shared by the plurality of devices. On the other hand, when a model library is newly generated according to an embodiment, states of devices of a netlist may be changed to a flatten state instead of hierarchy, and thus, different device models may be applied to the devices, whereby different deviations caused by aging may be applied to the devices.

The simulation tool 120A may be a software tool for predicting circuit characteristic, and for example, may use a simulation tool such as SPICE. For example, when a designed circuit does not accurately operate according to a designer's intention, the circuit may be corrected and again simulated, and thus, whether an operation of an IC is suitable may be checked before the IC is manufactured.

FIG. 2B illustrates an example where a function of applying a process variation to each device is included in a simulation tool.

For example, a simulation system 100B may include a schematic tool 110B and a simulation tool 120B according to embodiments. The simulation tool 120B may include a simulation unit 122B that performs a simulation using a netlist and a model library and may also include a process variation application unit 121B for applying a process variation of each device caused by aging according to the above-described embodiment. A detailed operation of the simulation system 100B of FIG. 2B is the same as or similar to the operation of FIG. 2A, and thus, its detailed description is not repeated.

The process variation application unit 121B may receive, from the schematic tool 110B, a netlist in which aging is not reflected, aging information including characteristic degradation information of each device caused by aging and a model library that includes deviation information which is applied to the devices in common The process variation application unit 121B may supply a modified netlist and a changed model library, which are newly generated through change based on received information, to the simulation unit 122B. The modified netlist may include, as instance parameters, differently calculated deviations of the devices. Alternatively, the newly generated model library may include a plurality of device models having different deviations of the devices. The modified netlist may include a model name for indicating a device model having unique deviation information.

Similar to the above description, an aging tool may be provided outside the schematic tool 110B, and for example, may be provided between the schematic tool 110B and the simulation tool 120B. For example, the aging tool may generate aging information by using a netlist and a model library and may supply the netlist, the model library, and the aging information to the simulation tool 120B.

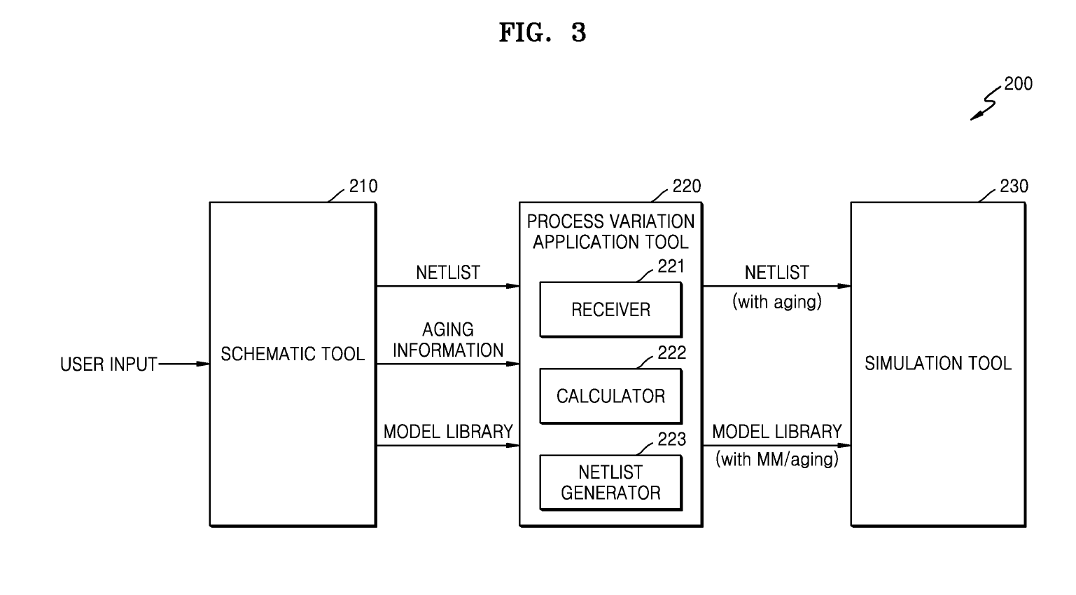

Referring to FIG. 3, a simulation system 200 may include a schematic tool 210, a process variation application tool 220, and a simulation tool 230 according to embodiments. The schematic tool 210, the process variation application tool 220, and the simulation tool 230 may each be implemented with a program executable by a computer. The process variation application tool 220 according to an embodiment may provide a netlist applied to a simulation and thus may be referred to as a schematic tool. In describing an example of a detailed operation of the simulation system 200, a detailed description of an operation which is the same as or similar to the above-described embodiment is not provided.

The schematic tool 210 may output a netlist indicating a circuit which is designed based on a user input. The netlist output from the schematic tool 210 may have information in which the characteristic degradation of each device caused by aging is not reflected. Also, a model library applied to circuit design may be provided from the schematic tool 210, and the model library may include a plurality of device models in which deviation information based on a manufacturing process is reflected. For example, the device models may be expressed as various pieces of parameter information, and some parameter information (for example, a deviation) may be based on the deviation information based on the manufacturing process. Also, although not shown in FIG. 3, the schematic tool 210 may further include a separate commercial tool (not shown) for generating the above-described aging information, and the commercial tool may be provided inside or outside the schematic tool 210. The aging information may be supplied to the process variation application tool 220.

According to embodiments, the process variation application tool 220 may receive a netlist and a model library, in which aging is not reflected, and provide a modified netlist and a changed model library which are generated based on the netlist, the model library and the aging information. In an embodiment, the process variation application tool 220 may include a receiver 221 that receives a netlist, a model library and aging information, a calculator 222 that calculates a deviation of each device caused by aging according to the above-described embodiment, and a netlist generator 223 that generates a modified netlist according to an arithmetic operation result. The process variation application tool 220 may check kinds of devices included in a circuit and a connection state between the devices with reference to a netlist and may determine a degree of characteristic degradation, caused by aging, of devices included in the schematic tool 210 with reference to aging information.

The process variation application tool 220 may output a modified netlist and a changed model library by performing an arithmetic operation based on the above-described information. For example, deviations of devices having different values may be calculated according to aging, and the calculated deviations may be reflected in at least one of the modified netlist and the changed model library. For example, in describing each of devices, the modified netlist may be generated by adding deviation information of each device, based on an instance parameter. Also, the changed model library may include a plurality of device models which are newly generated to have different deviations of devices. The newly generated plurality of device models may have different model names, and the modified netlist may indicate the newly generated device models, thereby applying different deviation values to devices.

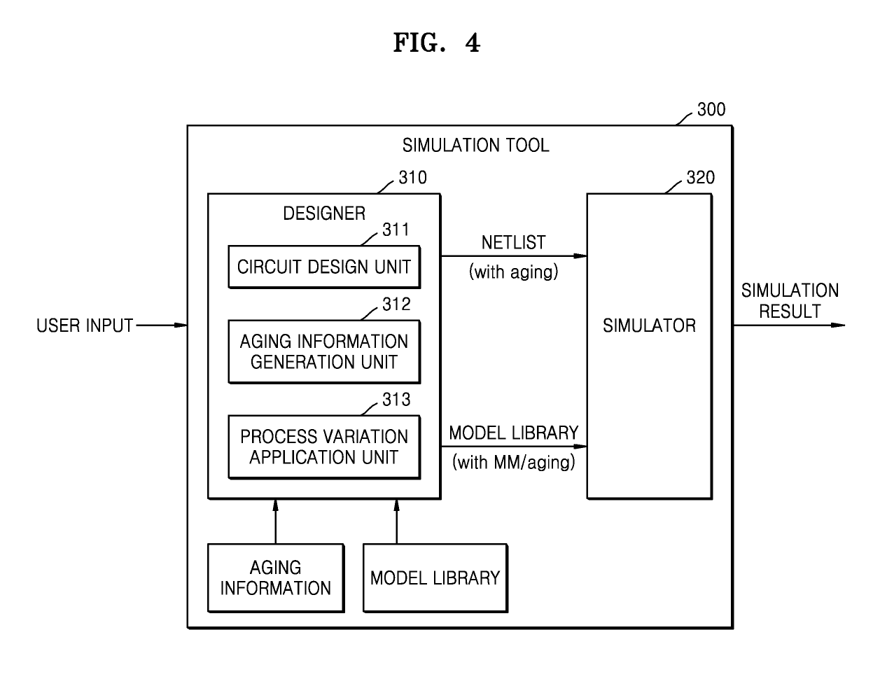

Referring to FIG. 4, a simulation system may be implemented with a simulation tool 300. That is, a circuit schematic function, a process deviation application function, and a simulation function according to the above-described embodiment may be performed by a simulation tool 300. In describing an example of a detailed operation of the simulation tool 300, a detailed description of an operation which is the same as or similar to the above-described embodiment is not provided.

The simulation tool 300 may include a designer 310 and a simulator 320. Also, the designer 310 may include a circuit design unit 311, an aging information generation unit 312, and a process variation application unit 313, which operate identically or similarly to the above-described embodiment. The circuit design unit 311 may provide a circuit which is designed according to a user input, and the process variation application unit 313 may generate a modified netlist and a changed model library by using a model library which includes aging information and deviation information in which aging is not reflected. Different deviations may be applied to devices by using the modified netlist and the changed model library in various methods. For example, the modified netlist (a netlist with aging) may include characteristic degradation information of each device caused by aging, and the changed model library (a model library with MM/aging) may include deviation information of each device caused by aging.

The information generated by the aging information generation unit 312 and the model library generated by the process variation application unit 313 may be stored in the simulation tool 300. Also, the simulator 320 may perform a simulation operation by using the modified netlist and the changed model library to generate an analysis result of a designed circuit.

According to the above-described embodiment, it may be described that the simulation tool or the circuit schematic tool according to embodiments performs various extraction operations. For example, the various extraction operations may be performed based on information which is supplied in association with a simulation, thereby extracting a model library and/or a netlist in which a process deviation caused by aging is reflected. For example, aging information may be primarily extracted from a model library and a netlist in which aging is not reflected, and a model library and/or a netlist in which a deviation caused by aging is reflected may be secondarily extracted by performing an arithmetic operation based on the aging information.

According to the above-described embodiments, provided is a design solution based on a process deviation which is changed depending on aging. That is, a variation change amount of each device caused by aging may be predicted, and a circuit for representing the variation change amount of each device may be designed, thereby enabling a robust circuit to be developed in terms of reliability and a process variation.

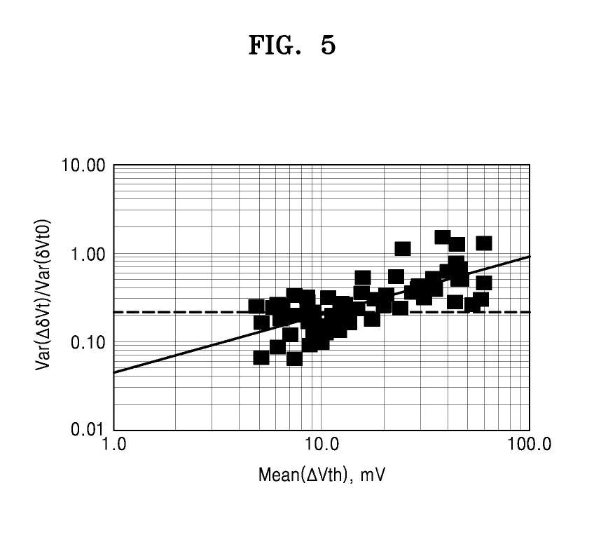

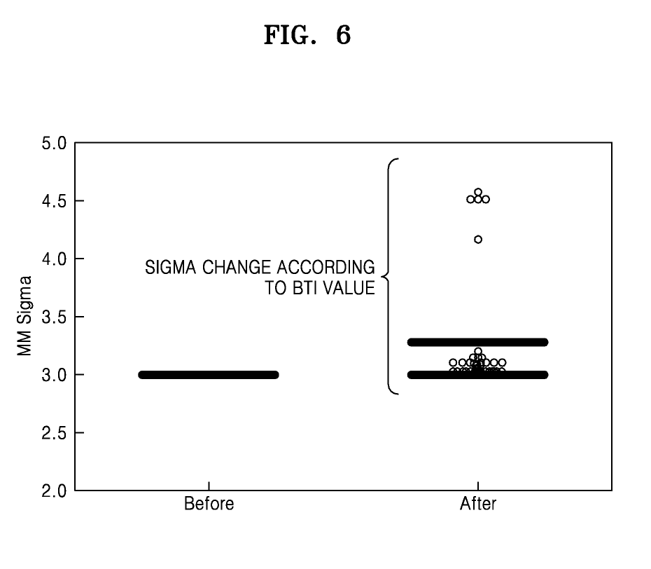

FIGS. 5 and 6 are graphs showing an example where devices have different process variations due to the progress of aging.

FIG. 5 shows an example where the characteristics of a plurality of devices included in an IC are variously changed due to aging. Referring to a transistor as an example of devices, a threshold voltage level of each of transistors may be changed as aging progresses, and distributions of the threshold voltage levels of the transistors may differ. In the graph of FIG. 5, the abscissa axis indicates a change amount of a mean of a threshold voltage, and the ordinate axis indicates a deviation of a threshold voltage.

As shown in FIG. 5, threshold voltage levels of aged devices may be variously changed depending on the aging characteristics of the aged devices. Also, a deviation of a threshold voltage of each of the devices may be relevant to a change amount of the threshold voltage level of a corresponding device. For example, when a certain transistor has a characteristic where the certain transistor is less affected by aging, a threshold voltage level of the certain transistor may be less changed due to aging, and a deviation of the threshold voltage level of the certain transistor may be small in a plurality of manufactured circuits. On the other hand, when a transistor has a characteristic where the certain transistor is largely affected by aging, a threshold voltage level of the transistor may be largely changed due to aging, and a deviation of the threshold voltage level of the transistor may be large in a plurality of manufactured circuits.

Referring to FIG. 6, a change amount of a process deviation (sigma) of each device caused by aging may be checked. The devices may have the same process deviation before aging progresses, but after aging progresses, the devices may be differently deteriorated, whereby the devices may have different process deviations. As shown in FIG. 6, the characteristics of some devices may be largely degraded and thus may have a very large deviation change amount. According to embodiments, an operation of a circuit may be more accurately predicted through a simulation based on process deviations of devices whose characteristics are largely degraded due to aging.

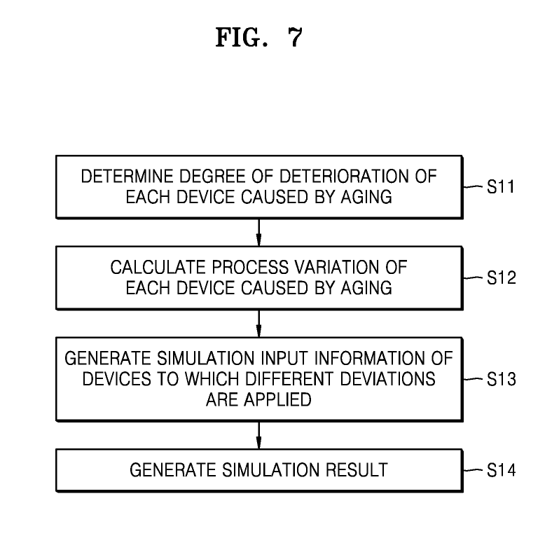

FIG. 7 is a flowchart illustrating a simulation method according to embodiments.

The simulation method according to embodiments may use a netlist in which an aging effect is not reflected, a model library in which a process variation is reflected, and characteristic degradation information of each device caused by aging. Also, the simulation method according to embodiments may generate a netlist, in which an aging effect is reflected, and a model library including the change characteristic of a process variation of each device caused by aging. Also, a simulation may be performed by using the generated netlist and model library as input information for the simulation.

Therefore, as illustrated in FIG. 7, the simulation method may determine a degree of deterioration of each device caused by aging, based on aging information in operation S11. Also, in operation S12, the simulation method may calculate a progress deviation of each device caused by aging, based on a model library in which a process variation is reflected and a degree of deterioration of each device caused by aging. Also, in operation S13, the simulation method may generate simulation input information about where different deviations are applied to the devices. The simulation input information may include a netlist and a model library according to the above-described embodiments. Also, in operation S 14, a simulation result may be generated and may be supplied to a designer.

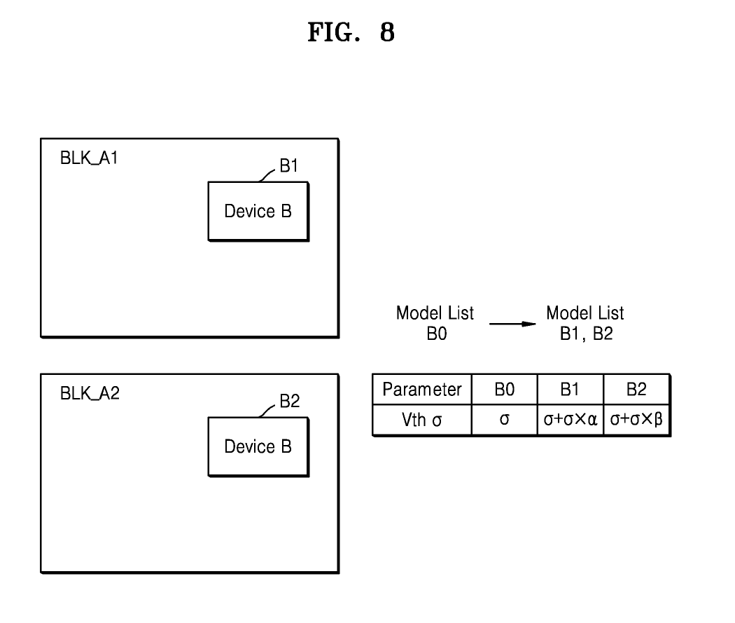

FIG. 8 is a diagram illustrating an example of generating (or changing) a model library in which a process variation caused by aging is reflected, according to embodiments.

As illustrated in FIG. 8, a designed circuit may include a plurality of blocks. For example, a first block BLK_A1 and a second block BLK_A2 may each include the same device B, and different bias conditions may be applied to the devices B of the blocks. That is, the device B of the first block BLK_A1 and the device B of the second block BLK_A2 may have different process variations caused by aging.

A plurality of new device models may be generated from an original device model B0 corresponding to the device B, and for example, a device model B1 corresponding to the device B of the first block BLK_A1 and a device model B2 corresponding to the device B of the second block BLK_A2 may be generated.

Moreover, parameters corresponding to the device models B1 and B2 may be defined by correcting some of a plurality of parameters included in the device model B0. For example, the plurality of parameters may include process parameters such as a channel, a width, a depth, and/or the like which configure a circuit element, and may also include electrical parameters such as a threshold voltage “Vth”. According to an embodiment, a deviation of each device caused by aging may be calculated based on one or more parameters selected from among the plurality of parameters.

For example, in correcting a deviation “σ” of a threshold voltage “Vth” which is a parameter included in the device model B0, a deviation of a threshold voltage “Vth” of the device model B1 may have a change amount equal to “σ*α”. Also, a deviation of a threshold voltage “Vth” of the device model B2 may have a change amount equal to “σ*β”.

When the device B of the first block BLK_A1 is relatively largely affected by aging, a may have a value relatively greater than β. The device B of the first block BLK_A1 and the device B of the second block BLK_A2 may be defined as different model names, and thus, a newly defined model name may be applied to a netlist which is provided as a simulation tool according to an embodiment.

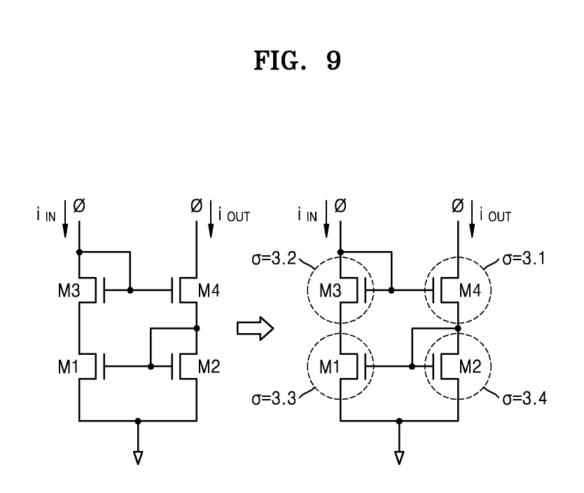

FIG. 9 is a circuit diagram illustrating an example where different deviations are applied to devices, according to embodiments. In FIG. 9, an example where different deviations “σ” are applied to devices is illustrated, and a device denotes a transistor.

A designed circuit may include a plurality of transistors M1 to M4, and the transistors M1 to M4 may have different characteristic changes caused by aging and may have different process variations. Different deviations “σ” of the devices caused by aging may be calculated. For example, a deviation “σ” of 3.3 may be applied to a first transistor M1, a deviation “σ” of 3.4 may be applied to a second transistor M2, a deviation “σ” of 3.2 may be applied to a third transistor M3, and a deviation “σ” of 3.1 may be applied to a fourth transistor M4, whereby a simulation may be performed.

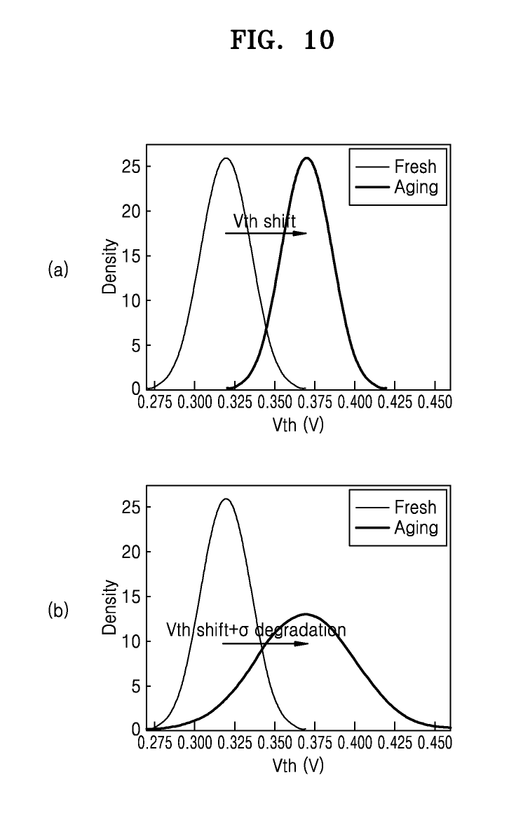

FIG. 10 is a graph showing an example of a process variation of a simulated device.

In a case of using a model library and a netlist to which a change in a process variation caused by aging is not applied, a simulation may be performed by using a process variation of FIG. 10A as a model. For example, as aging progresses, a mean of a parameter (for example, a threshold voltage “Vth”) of each device may be changed, but since the devices are set to have the same deviation, widths of process variations of the devices may have the same value irrespective of aging. However, actually, the process variations of the devices may be differently changed as aging progresses, and the simulation using the process variation of FIG. 10A as the model cannot accurately reflect the actual characteristic of a circuit.

On the other hand, in a case of using a model library and a netlist to which a process variation caused by aging is applied, a simulation may be performed by using a process variation of FIG. 10B as a model. That is, as aging progresses, a mean and a deviation “σ” of a parameter (for example, a threshold voltage “Vth”) of each device may be changed. This may denote that the actual characteristic change of each device caused by the progress of aging is reflected. Accordingly, a more accurate simulation result is obtained.

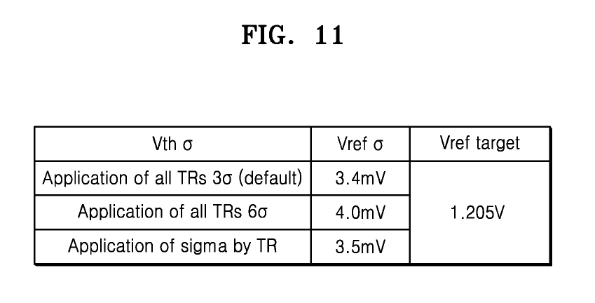

FIG. 11 is a table showing an example of a simulation result based on a process variation of a threshold voltage of a transistor.

As shown in FIG. 11, in a case of performing a simulation by changing a threshold voltage of a transistor, a level of a reference voltage “Vref” used in a designed circuit may be changed according to an operation of the designed circuit. For example, as a process variation of a threshold voltage of a transistor is changed, a level variation of the reference voltage “Vref” may be changed.

For example, when deviations “σ” of threshold voltages of transistors are identically applied as a value “3*σ”, a deviation “Vref σ” of a level of the reference voltage “Vref” may have about 3.4 mV. Also, for example, when the deviations “σ” of the threshold voltages of the transistors are identically applied as a value “6*”, the deviation “Vref σ” of the level of the reference voltage “Vref” may have about 4.0 mV. Also, when different deviations “σ” are applied to the transistors, the deviation “Vref σ” of the level of the reference voltage “Vref” may have about 3.5 mV. Also, it is assumed that a target value of the level of the reference voltage “Vref” leads to a result corresponding to 1.205 V.

Referring to the simulation result, in a case where a value when the level of the reference voltage “Vref” is changed from a target value to a value which is approximately six times the deviation “Vref σ” is within a range which enables a circuit to be trimmed, it may be determined that the circuit is designed to normally operate. For example, when the deviations “σ” of the threshold voltages of the transistors are identically applied as a value “3*σ”, whether a value “1.185 V to 1.225 V” which is obtained by changing the level of the reference voltage “Vref” to “6*Vref σ(3.4 mV*6=±20.4 mV)” is within a range which enables a circuit to be trimmed may be determined

According to an embodiment, a deviation “σ” of a threshold voltage in which an actual characteristic change of a device is reflected may be applied, and the deviation “Vref σ” of the level of the reference voltage “Vref” may be accurately calculated as a simulation result to which the deviation “σ” of the threshold voltage is applied, whereby whether a corresponding circuit is designed to normally operate may be accurately verified. For example, when a design margin is very widely set (for example, when six times a deviation is applied), although an actual circuit normally operates through trimming, a simulation result may be obtained as deviating from an allowable reference. However, according to embodiments, such problems are solved.

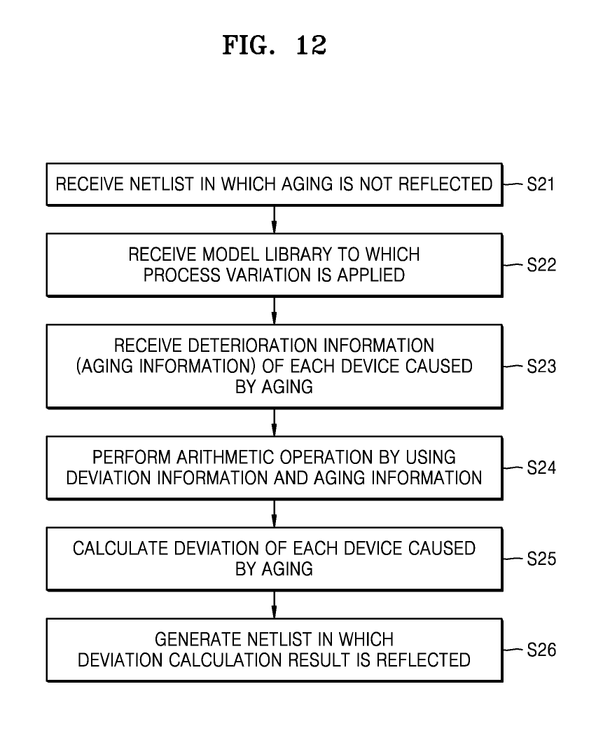

FIG. 12 is a flowchart illustrating a simulation method according to an embodiment. In FIG. 12, an example where a process variation caused by aging is reflected in a netlist is illustrated.

As illustrated in FIG. 12, in operation S21, a process variation application tool according to embodiments may receive a netlist in which aging is not reflected. Also, in operation S22, the process variation application tool may receive a model library to which a process variation is applied. The process variation may correspond to deviation information in which aging is not reflected. The process variation application tool may include deterioration (or characteristic degradation) information of each device caused by aging, or may receive the deterioration (or aging information) information of each device caused by aging in operation S23.

A certain equation for calculating different deviations of the devices based on the information may be defined and included in the process variation application tool. The process variation application tool may perform an arithmetic operation by using deviation information of the devices and aging information of the devices in operation S24, and may calculate, as a result of the arithmetic operation, a deviation of each device caused by aging in operation S25. As described above, the calculated deviation of each device may be reflected in a netlist. For example, in defining each of a plurality of devices included in a designed circuit, a netlist in which a deviation calculation result is reflected may be generated by adding instance parameters having different deviations of the devices in operation S26.

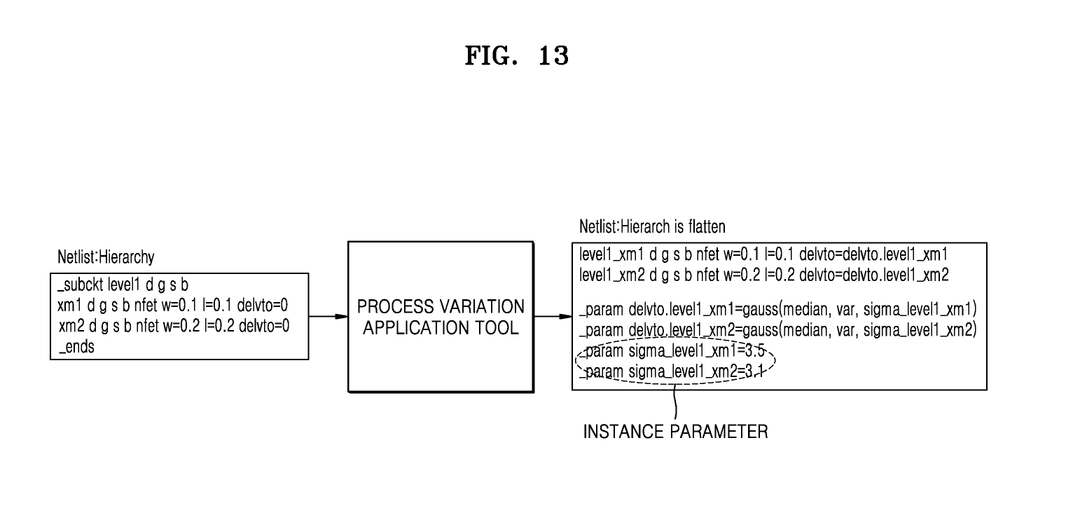

FIG. 13 is a diagram illustrating an example of a netlist associated with an operation according to the embodiment of FIG. 12. In FIG. 13, a netlist to which a process variation input to a process variation application tool according to an embodiment is not applied and a netlist to which a process variation output from the process variation application tool is applied are illustrated as an example.

As illustrated in FIG. 13, the netlist input to the process variation application tool may have a certain hierarchical structure, but a structure of the netlist output from the process variation application tool may be changed from a hierarchical state to a flatten state. Also, in the netlist output from the process variation application tool, instance parameters may be respectively added into devices xm1 and xm2 included in a certain lower structure “level 1”. For example, an example where a deviation of 3.5 caused by aging is applied to a first device xm1 as an instance parameter and a deviation of 3.1 caused by aging is applied to a second device xm2 as an instance parameter is illustrated.

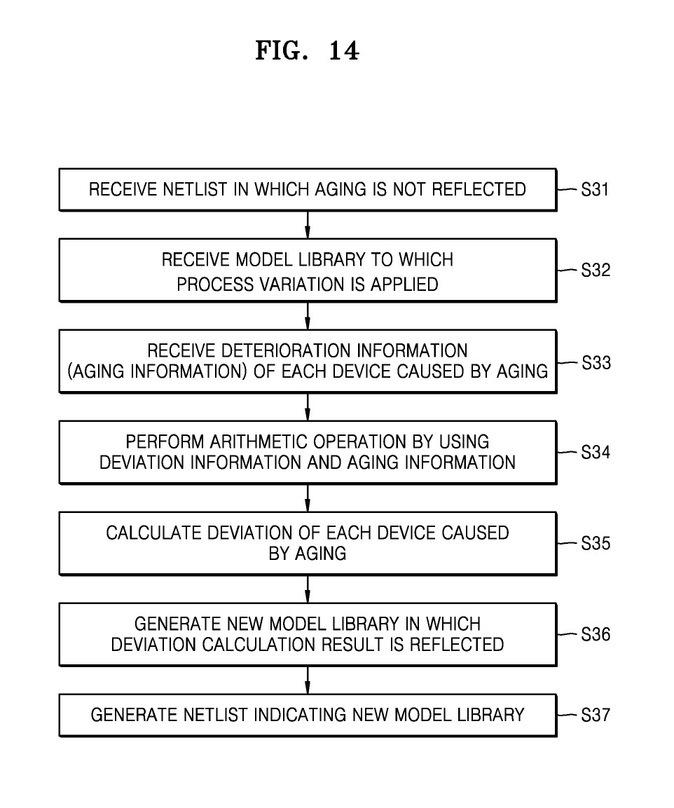

FIG. 14 is a flowchart illustrating a simulation method according to another embodiment. In FIG. 14, an example is illustrated where a process variation caused by aging is reflected in a netlist and a model library. In describing elements of FIG. 14, detailed descriptions of elements which are the same as or similar to the elements of FIG. 12 are not provided.

As illustrated in FIG. 14, in operation S31, a process variation application tool according to embodiments may receive a netlist in which aging is not reflected. In operation S32, the process variation application tool may receive a model library to which a process variation is applied. In operation S33, the process variation application tool may receive deterioration (or aging degradation) information of each device caused by aging. In operation S34, an arithmetic operation may be performed based on deviation information and the aging information. In operation S35, a deviation of each device caused by aging may be calculated as a result of the arithmetic operation.

A result of the calculation may be reflected in an operation of generating a new device model. For example, a plurality of device models in which one or more process variations caused by aging are reflected may be generated from one device model which are applied to a plurality of devices in common, and the newly generated device models may configure a new model library. That is, a new model library in which the deviation calculation result is reflected may be generated in operation S36.

In operation S37, a netlist indicating a plurality of new device models included in the new model library may be generated. For example, a designed circuit may include a plurality of devices having different process deviations, and the plurality of devices may correspond to a plurality of device models having different device names. The netlist may indicate the new device models having unique deviations caused by aging, and thus, a simulation in which a process variation is reflected may be performed based on the netlist.

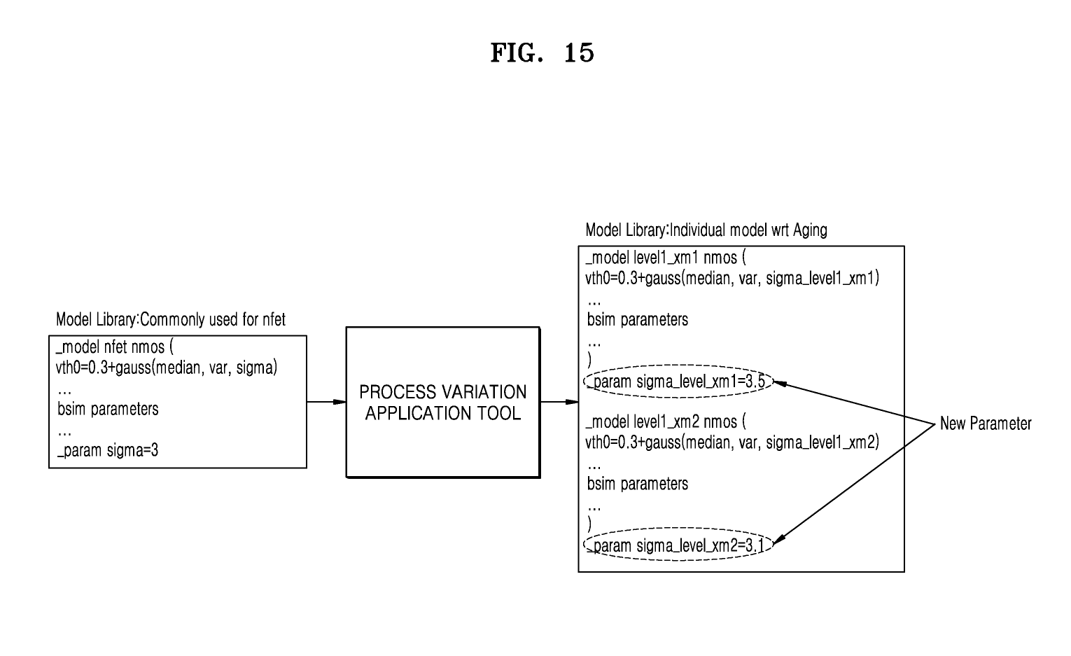

FIG. 15 is a diagram illustrating an example of a model library associated with an operation according to the embodiment of FIG. 14.

Referring to FIG. 15, a model library input to a process variation application tool may include a device model which is applied to a plurality of devices in common, and the device model may include a parameter corresponding to a deviation (for example, sigma 3) of a process variation which is applied to the plurality of devices in common without aging being reflected therein.

On the other hand, a model library output from the process variation application tool may include a plurality of device models which are separately applied to the plurality of devices, and the device models may include parameters which have different values and are relevant to a deviation of a process variation in which aging is reflected. For example, a device model may correspond to a first device xm1 and may include, as a parameter, a deviation of 3.5 caused by aging. Also, a device model may correspond to a second device xm2 and may include, as a parameter, a deviation of 3.1 caused by aging.

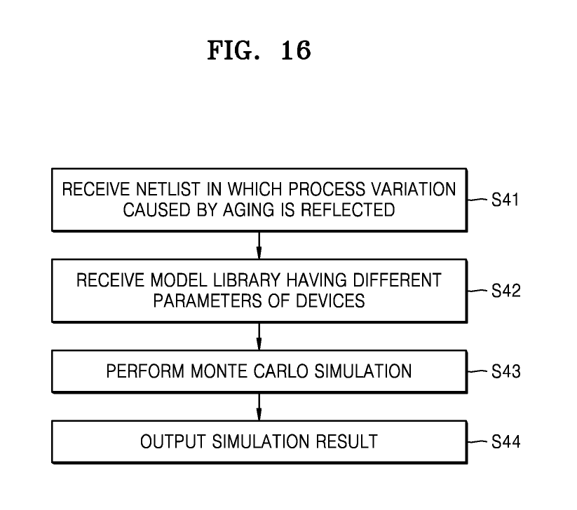

FIG. 16 is a flowchart illustrating a simulation method according to another embodiment. In FIG. 16, an example is illustrated where a Monte Carlo simulation obtaining a circuit response is performed while randomly changing values of parameters of a device model is performed.

According to embodiments, a mean and a deviation of a parameter corresponding to each of multiple devices may be calculated, and thus, a simulation may be performed while randomly changing a value of the parameter of each device within a range of the deviation. Therefore, a variation result representing defects of circuits (for example, semiconductor circuits) manufactured through the same manufacturing process may be obtained.

For example, in operation S41, a simulation tool may receive a netlist in which a process variation caused by aging is reflected according to a method which is the same as or similar to the above-described embodiments. In operation S42, the simulation tool may receive a model library including different parameters of devices. The netlist in which the process variation caused by aging is reflected may be defined in various forms, and for example, in a case where a deviation of each device is reflected in the netlist, the process variation caused by aging may be reflected in the netlist by adding an instance parameter. Alternatively, when a new model library having a deviation of each device is generated, the process variation caused by aging may be reflected in the netlist by indicating a device model of the new model library. Also, according to an embodiment, when the deviation information is included in the netlist, the model library including the different parameters of the devices may not be generated separately.

Subsequently, the Monte Carlo simulation may be performed based on the netlist and the model library in operation S43, and a result of the simulation may be output in operation S44.

In a circuit simulation according to the above-described embodiments, an accurate result of a simulation which is performed for designed circuits of various semiconductor devices (for example, PMIC, DDI, and/or the like) having a process variation which is largely changed due to aging may be provided. Furthermore, an accurate result of a simulation which is performed for a memory design such as static random access (SRAM) where a margin of a process variation is a logic IP may be provided.

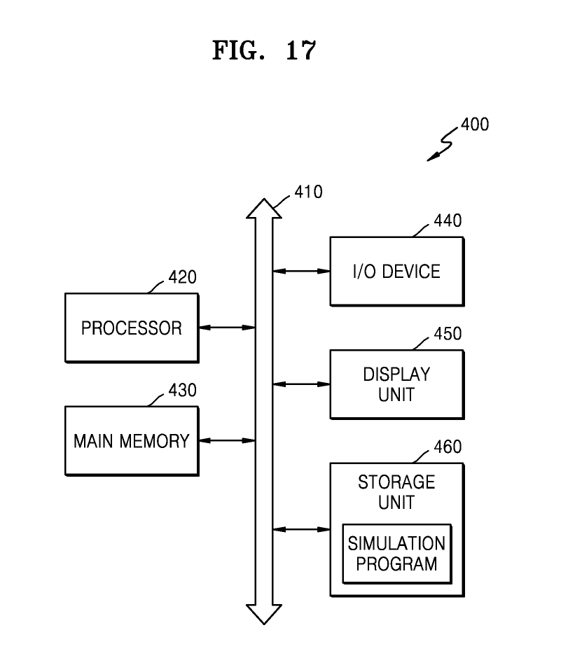

FIG. 17 is a block diagram illustrating a computing system 400 for performing a simulation method, according to an embodiment. Referring to FIG. 17, the computing system 400 may include a system bus 410, a processor 420, a main memory 430, an input/output (I/O) device 440, a display unit 450, and a storage unit 460. The processor 420 may be configured with a single core or a multi-core. The I/O device 440 may include a keyboard, a mouse, a printer, and/or the like. The main memory 430 may be a volatile memory such as dynamic random access memory (DRAM), SRAM, or the like. The display unit 450 may include a display device such as a liquid crystal display (LCD), a light-emitting diode (LED) display, an organic light-emitting display (OLED) display, or the like. The storage unit 460 may include a nonvolatile memory such as hard disc drive (HDD), solid state drive (SSD), or the like.

The storage unit 460 may store program codes (for example, computer-readable program codes) for performing the simulation method according to the above-described embodiments. The program codes may be loaded into the main memory 430 and may be executed by the processor 420, and a simulation result which is a result of the execution may be output to the I/O device 440 or the display unit 450. According to an embodiment, the storage unit 460 may store characteristic degradation information (for example, aging information) caused by aging, and the program codes may include codes for generating a netlist and/or a model library, in which a process variation caused by aging is reflected, by using a model library in which the process variation is reflected and the aging information.

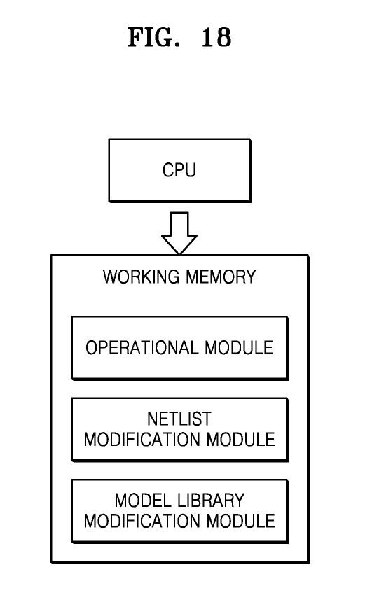

FIG. 18 is a block diagram illustrating an example where a function according to embodiments is implemented in software. Referring to FIG. 18, a central processing unit (CPU) 1810 may execute programs stored in a working memory 1820. The programs may include an operational module 1830, a netlist modification module 1840, and a model library modification module 1850 depending on functions thereof. A process variation application function based on aging according to the above-described embodiments may be performed by executing the programs.

For example, by executing the operational module 1830, deviations having different values may be calculated for devices depending on aging. For example, an arithmetic operation based on aging information and information about a process variation may be performed by executing the operational module 1830.

Moreover, by executing the netlist modification module 1840, a netlist may be modified in order for a result of the deviation calculation to be reflected therein. Also, device models in which the deviation calculation result is reflected may be generated by executing the model library modification module 1850. That is, as a result obtained by executing the programs stored in the working memory 1820, a netlist and/or a model library in which a deviation caused by aging is reflected may be generated for each of devices.

In an embodiment illustrated in FIG. 18, the CPU 1810 and the working memory 1820 may configure a process variation application tool, or a storage medium storing a CPU-readable program may configure the process variation application tool.

As described above, in the circuit design method and the simulation method according to the embodiments, a process variation caused by aging may be predicted for each of the devices included in an IC, and a simulation in which a result of the prediction is reflected may be performed, thereby enabling the characteristic of a circuit to be more accurately verified.

As is traditional in the field, embodiments may be described and illustrated in terms of blocks which carry out a described function or functions. These blocks, which may be referred to herein as units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to per-form other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

While the disclosure has been particularly shown and described with reference to embodiments thereof, it will be understood that various changes in form and details may be made therein without departing from the spirit and scope of the following claims.

1. A circuit design method comprising:
extracting aging information of each of one or more devices using a netlist including the one or more devices and a model library including information associated with a process variation;
calculating a deviation of the process variation due to aging by performing an arithmetic operation using the information associated with the process variation and the aging information, for each of the one or more devices; and
extracting a revised netlist or a revised model library, wherein
the calculated deviation is reflected in the revised netlist or revised model library.

2. The circuit design method of claim 1, wherein the aging information is generated by a commercial tool that calculates characteristic degradation information, caused by aging for each of the one or more devices included in the netlist, by performing a simulation using the netlist.

3. The circuit design method of claim 1, wherein extracting the revised netlist or revised model library comprises reflecting the calculated deviation of each of the one or more devices in the revised netlist as an instance parameter.

4. The circuit design method of claim 1, wherein extracting the revised netlist or revised model library comprises generating one or more device models including a parameter indicating the calculated deviation of each of the one or more devices.

5. The circuit design method of claim 4, wherein one or more devices included in the extracted netlist correspond to the generated one or more device models.

6. The circuit design method of claim 1, wherein aging is not reflected in the netlist of the one or more devices.

7. The circuit design method of claim 1, wherein:
the revised netlist comprises information associated with a mean of the process variation in which the aging of the one or more devices is reflected, and
the revised model library comprises information associated with the deviation of the process variation in which the aging of the one or more devices is reflected.

8. The circuit design method of claim 1, wherein:
the one or more devices respectively correspond to one or more transistors, and
the information associated with the process variation corresponds to a variation of a threshold voltage level of each of the one or more transistors.

9. The circuit design method of claim 8, wherein:
the one or more devices comprise first and second transistors, and
the first and second transistors described by the revised netlist or model library comprise different variations of threshold voltage levels.

10. A circuit design method comprising:
receiving a netlist;
performing an arithmetic operation by using information associated with process variations of a plurality of devices included in the netlist and aging information indicating a degree of characteristic degradation due to aging for each of the devices;
calculating a deviation in which the aging is reflected for each of the devices, based on a result of the arithmetic operation; and
outputting a modified netlist according to the calculated deviation.

11. The circuit design method of claim 10, further comprising receiving a model library including the information associated with the process variations, wherein the model library includes deviation information having a common value for the plurality of devices.

12. The circuit design method of claim 11, wherein the modified netlist is generated by adding the calculated deviation of each of the plurality of devices as an instance parameter to the netlist, in which the aging is not reflected.

13. The circuit design method of claim 11, further comprising generating one or more device models including a parameter indicating the calculated deviation of each of the plurality of devices.

14. The circuit design method of claim 13, wherein the modified netlist comprises one or more devices corresponding to the generated one or more device models.

15. The circuit design method of claim 10, wherein:
in a device in which the degree of characteristic degradation caused by aging is high, the calculated deviation of the device is low, and
in a device in which the degree of characteristic degradation caused by aging is low, the calculated deviation of the device is high.

16. The circuit design method of claim 10, wherein:
the received netlist comprises a plurality of blocks,
a first block of the plurality of blocks comprises a first device, and a second block of the plurality of blocks comprises a second device, and
in the modified netlist, a calculated deviation for the first device differs from a calculated deviation for the second device.

17. A circuit simulation method comprising:
receiving a netlist and a model library, the model library including information associated with a process variation of a plurality of devices;
calculating a deviation due to aging of each of the plurality of devices based on the information included in the model library and aging information of each of the plurality of devices, the aging information indicating a degree of characteristic degradation caused by aging; and
performing a simulation using a modified netlist generated based on the calculated deviation.

18. The circuit simulation method of claim 17, further comprising:
performing a simulation by using the netlist and the model library, wherein
the aging information is generated by the simulation using the netlist and the model library, and the degrees of characteristic degradation caused by aging differ among the plurality of devices.

19. The circuit simulation method of claim 17, wherein:
the modified netlist is generated by adding the calculated deviation of each of the plurality of devices as an instance parameter to the netlist, and
the aging information is not reflected in the netlist.

20. The circuit simulation method of claim 17, further comprising generating, for each of the plurality of devices, a device model including a parameter indicating the calculated deviation.

21-29. (canceled)
